(19) United States
(12) Patent Application Publication
(10) Pub. No.: US 2012/0188396 A1
(43) Pub. Date: Jul. 26, 2012

(54) DIGITAL PHOTOGRAPHING APPARATUSES, METHODS OF CONTROLLING THE SAME, AND COMPUTER-READABLE STORAGE MEDIA

(75) Inventor: Hye-jin Kim, Seoul (KR)

(73) Assignee: Samsung Electronics Co., Ltd., Suwon-si (KR)

(21) Appl. No.: 13/343,981

(22) Filed: Jan. 5, 2012

Related U.S. Application Data
(63) Continuation of application No. 13/195,976, filed on Aug. 2, 2011.

(30) Foreign Application Priority Data
Jan. 24, 2011 (KR) 10-2011-0006812

(51) Int. Cl. H04N 5/228

(52) U.S. Cl. 348/222.1; 348/E05.031

(57) ABSTRACT

A disclosed example method of controlling a digital photographing apparatus includes: combining a photographed image and object information indicating information regarding a subject; generating a composite image by combining the photographed image and the object information; and generating an image file including the composite image in a main image region and including the object information in an object property region.

### CROSS-REFERENCE TO RELATED PATENT APPLICATIONS

This application is a continuation of U.S. patent application Ser. No. 13/195,976, filed on Aug. 2, 2011, which claims the priority benefit of Korean Patent Application No. 10-2011-0006812, filed on Jan. 24, 2011, in the Korean Intellectual Property Office, the entirety of which is incorporated herein by reference.

### BACKGROUND

1. Field of the Disclosure

The present disclosure relates to digital photographing apparatuses, methods of controlling the digital photographing apparatuses, and computer-readable storage media storing a program for executing the methods of controlling the digital photographing apparatuses.

2. Description of the Related Art

A digital photographing apparatus may display or store a captured image acquired by an imaging device. Recently, digital photographing apparatuses having a wireless communication function enable users to acquire various types of information through the digital photographing apparatuses. For example, a wireless Internet function, a global positioning system (GPS) function, etc. may be embedded in digital photographing apparatuses.

### SUMMARY

Disclosed embodiments store object information indicating information about a subject and an image together, thereby accumulating the object information and increasing its utility. Disclosed embodiments also efficiently manage the accumulated object information, and enable searches for the object information. Disclosed embodiments enable a user to read the object information from stored image files even in a no communication environment.

According to an aspect of the invention, there is provided a method of controlling a digital photographing apparatus, the method including: combining a photographed image and object information indicating information regarding a subject; generating a composite image by combining the photographed image and the object information; and generating an image file including the composite image in a main image region and including the object information in an object property region.

The method may further include: editing the object information; generating the composite image by combining the edited object information and the photographed image; and generating the image file including the edited object information in the object property region.

The editing of the object information may include any of: adding information input by a user to the object information; modifying the object information according to a user's input; and excluding the object information deleted by the user from the object information.

The method may further include: identifying a property of the object information; and managing the image file according to the identified property of the object information.

The method may further include: searching for the image file according to the object information.

The object information may be information regarding the subject provided through augmented reality (AR).

The method may further include: providing the object information by searching for the object information according to a photographing position and a photographing azimuth.

According to another aspect of the invention, there is provided a digital photographing apparatus, including: an imaging device for generating a photographed image; an object information combining unit for combining the photographed image and object information indicating information regarding a subject; a composite image generating unit for generating a composite image by combining the photographed image and the object information; and a file generating unit for generating an image file including the composite image in a main image region and including the object information in an object property region.

The digital photographing apparatus may further include: an object information editing unit for editing the object information, wherein the composite image generating unit generates the composite image by combining the edited object information and the photographed image, and the file generating unit generates the image file including the edited object information in the object property region.

The object information editing unit may add information input by a user to the object information, modify the object information according to a user's input, or exclude the object information deleted by the user from the object information.

The digital photographing apparatus may further include: a file managing unit for identifying property of the object information and managing the image file according to the identified property of the object information.

The digital photographing apparatus may further include: a file searching unit for searching for the image file according to the object information.

The object information may be information regarding the subject provided through AR.

The digital photographing apparatus may further include: an object information providing unit for providing the object information by searching for the object information according to a photographing position and a photographing azimuth.

According to another aspect of the invention, there is provided a computer-readable storage medium storing a program that, when executed, causes a digital photographing apparatus to at least: combine a photographed image and object information indicating information regarding a subject; generate a composite image by combining the photographed image and the object information; and generate an image file including the composite image in a main image region and including the object information in an object property region.

### BRIEF DESCRIPTION OF THE DRAWINGS

The above and other features and advantages of the invention will become more apparent by describing in detail exemplary embodiments thereof with reference to the attached drawings in which:

FIG. 1 is a block diagram illustrating a digital photographing apparatus, according to an exemplary embodiment of the invention;

FIG. 2 is a block diagram illustrating a central processing unit (CPU)/digital signal processor (DSP), according to an exemplary embodiment of the invention;

FIG. 3 illustrates a screen displaying an image and object information together through a display unit, according to an exemplary embodiment of the invention;

FIG. 4 illustrates a screen displaying an object information edit interface, according to an exemplary embodiment of the invention;

FIG. 5 is a table showing a structure of an image file, according to an exemplary embodiment of the invention;

FIG. 6 illustrates information included in object information, according to an exemplary embodiment of the invention;

FIG. 7 is a flowchart illustrating a method of generating an image file including object information, according to another exemplary embodiment of the invention;

FIG. 8 is a block diagram illustrating a CPU/DSP, according to another exemplary embodiment of the invention;

FIG. 9 illustrates a classification of image files according to categories of object information, according to an exemplary embodiment of the invention; and

FIG. 10 illustrates a search interface, according to an exemplary embodiment of the invention.

### DETAILED DESCRIPTION OF THE INVENTION

The invention will now be described more fully with reference to the accompanying drawings, in which exemplary embodiments of the invention are shown. The following description and the accompanying drawings are to enable understanding of the operations of the invention, and portions that can easily be understood by those skilled in the art may be omitted.

Although certain embodiments are shown in the accompanying drawings and described herein, the scope of the invention is not limited thereto. On the contrary, the invention covers all methods, apparatus and computer-readable storage media fairly falling within the scope of the claims.

Hereinafter, embodiments of the invention will be described with reference to the accompanying drawings.

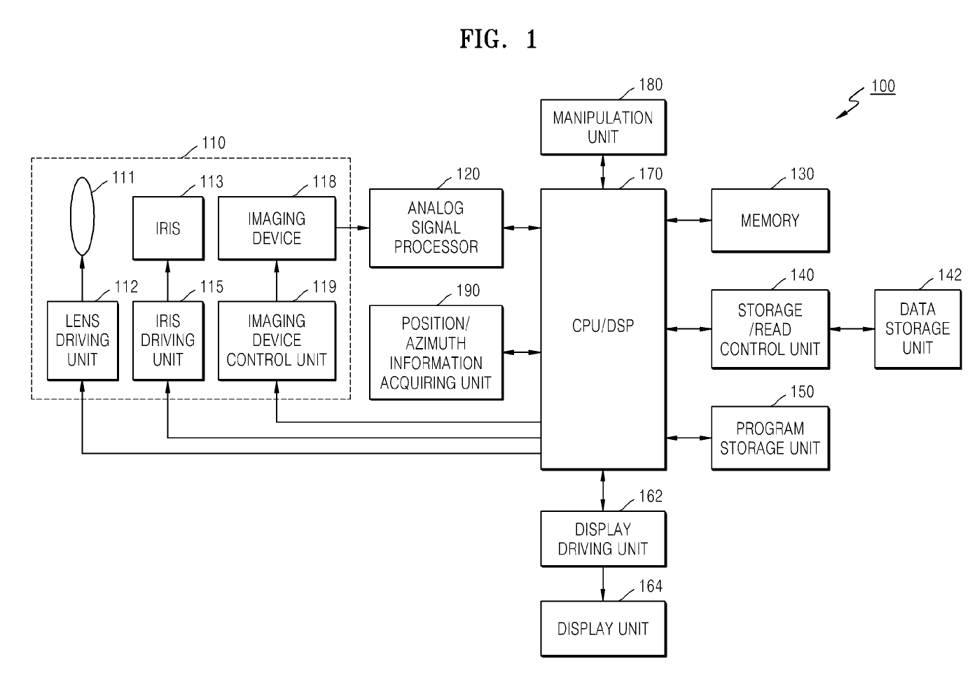

FIG. 1 is a block diagram illustrating a digital photographing apparatus 100, according to an exemplary embodiment of the invention.

Referring to FIG. 1, the digital photographing apparatus 100, according to the present embodiment, may include a photographing unit 110, an analog signal processor 120, a memory 130, a storage/read control unit 140, a data storage unit 142, a program storage unit 150, a display driving unit 162, a display unit 164, a CPU/DSP 170, a manipulation unit 180, and a position/azimuth information acquiring unit 190.

The overall operation of the digital photographing apparatus 100 is controlled and managed by the CPU/DSP 170. The CPU/DSP 170 provides a lens driving unit 112, an iris driving unit 115, and an imaging device control unit 119 with control signals for controlling operations of the lens driving unit 112, the iris driving unit 115, and the imaging device control unit 119.

The photographing unit 110 includes a lens 111, the lens driving unit 112, an iris 113, the iris driving unit 115, an imaging device 118, and the imaging device control unit 119 as elements for generating an image represented by an electrical signal from incident light.

The lens 111 may include a plurality of groups of lenses and a plurality of sheets of lenses. A position of the lens 111 is adjusted by the lens driving unit 112. The lens driving unit 112 adjusts the position of the lens 111 according to the control signal provided by the CPU/DSP 170.

A degree of opening/shutting of the iris 113 is controlled by the lens driving unit 115. The iris 113 controls an amount of light incident to the imaging device 118.

An optical signal that passes through the lens 111 and the iris 113 is transferred to the light-receiving surface of the imaging device 118 and forms an image of a subject. The imaging device 118 may be a charge coupled device (CCD) image sensor or a complementary metal oxide semiconductor image sensor (CIS) that converts an optical signal into an electrical signal. The sensitivity of the imaging device 118 may be adjusted by the imaging device control unit 119. The imaging device control unit 119 may control the imaging device 118 according to a control signal that is automatically generated by an image signal that is input in real-time or a control signal that is manually input according to manipulation of a user.

An exposure time of the imaging device 118 is controlled by a shutter (not shown). The shutter (not shown) includes a mechanical shutter that moves a shade to control light to be incident or an electronic shutter that supplies an electrical signal to the imaging device 118 to control exposure.

The analog signal processor 120 performs noise reduction processing, gain adjustment, waveform standardization, and analog-to-digital conversion, for an analog signal that is supplied from the imaging device 118.

A signal processed by the analog signal processor 120 may be input to the CPU/DSP 170 through the memory 130, or may be input to the CPU/DSP 170 without passing through the memory 130. In this regard, the memory 130 operates as a main memory of the digital photographing apparatus 100, and temporarily stores necessary information during an operation of the CPU/DSP 170. The program storage unit 130 stores an application system for driving the digital photographing apparatus 100 and a program of an operating system.

Furthermore, the digital photographing apparatus 100 includes the display unit 164 for displaying an operation state thereof or information about an image photographed thereby. The display unit 164 may provide the user with visual information and/or auditory information. To provide visual information, for example, the display unit 164 may include a liquid crystal display (LCD) panel or an organic light emitting display (OLED) panel. Moreover, the display unit 164 may be a touch screen capable of recognizing a touch input.

The display driving unit 162 provides the display unit 164 with a driving signal.

The CPU/DSP 170 processes an input image signal, and controls other elements of the digital photographing apparatus 100 according to the input image signal and/or an external input signal. The CPU/DSP 170 may reduce noise in input image data, and may perform image signal processing such as gamma correction, color filter array interpolation, color matrix, color correction, and color enhancement for improving image quality. Moreover, the CPU/DSP 170 may generate an image file by compressing the image data generated by performing the image signal processing for improving image quality, or may restore the image data from the image file. An image compression scheme may be reversible or irreversible. As an example of an appropriate compression scheme, a still image may be converted into a Joint Photographic Experts Group (JPEG) scheme or a JPEG 2000 scheme. A moving image may be generated by compressing a plurality of frames according to the Moving Picture Experts Group (MPEG) standard. The image file may be generated according to, for example, the Exchangeable Image File Format (Exif) standard.

The image data output from the CPU/DSP 170 is input into the storage/read controller 140 through the memory 130 or directly. The storage/read controller 140 stores the image data in the data storage unit 142 according to a signal from a user or automatically. Moreover, the storage/read controller 140 may read data for an image from the image file that is stored in the data storage unit 142, and may input the read data to the display driving unit 162 through the memory 130 or another path to display the image on the display unit 164. The data storage unit 142 may be detachable, or may be permanently connected to the digital photographing apparatus 100.

Moreover, the CPU/DSP 170 may perform unclearness processing, color processing, blurring processing, edge emphasis processing, image analysis processing, image recognition processing, and image effect processing. The CPU/DSP 170 may also perform face recognition processing and scene recognition processing as the image recognition processing. In addition, the CPU/DSP 170 may perform display image signal processing for displaying an image on the display unit 164. For example, the CPU/DSP 170 may perform brightness level control, color correction, contrast control, contour emphasis control, screen segmentation processing, character image generation, and image combining processing. The CPU/DSP 170 may be connected to an external monitor and perform image signal processing for an image to be displayed on the external monitor. The CPU/DSP 170 may transmit the processed image data, thereby allowing a corresponding image to be displayed on the external monitor.

Moreover, the CPU/DSP 170 may execute a program that is stored in the program storage unit 130, or include a separate module, generate a control signal for controlling auto focusing, zooming, focusing, and auto exposure correction, provide the control signal to the iris driving unit 115, the lens driving unit 112, and the imaging device control unit 119, and generally control the operations of the elements of the digital photographing apparatus 100, such as a shutter and a flash.

The manipulation unit 180 is an element via which a user may input a control signal. The manipulation unit 180 may include various function buttons such as a shutter-release button, a power on/off button, a zoom button, other photographing setting value control buttons, etc. The shutter-release button is one for inputting a shutter-release signal that allows a photograph to be captured by exposing the imaging device 118 to light for a predetermined time. The power on/off button is one that inputs a control signal for controlling on/off of a power source. The zoom button is for widening or narrowing an angle of view according to an input. The manipulation unit 180 may be implemented in various other ways by which a user can input a control signal, like a button, a keyboard, a touch pad, a touch screen or a remote controller.

The position/azimuth acquiring unit 190 calculates a position and an azimuth of the digital photographing apparatus 100. For example, the position/azimuth acquiring unit 190 may include a GPS module for receiving a GPS signal and acquiring position information, and/or a digital compass for acquiring azimuth information. As another example, the position/azimuth acquiring unit 190 may calculate the azimuth of the digital photographing apparatus 100 by using two pieces of position information by including GPS modules at two points of the digital photographing apparatus 100. In addition, the position/azimuth acquiring unit 190 may be configured in various other ways to calculate the position and the azimuth of the digital photographing apparatus 100.

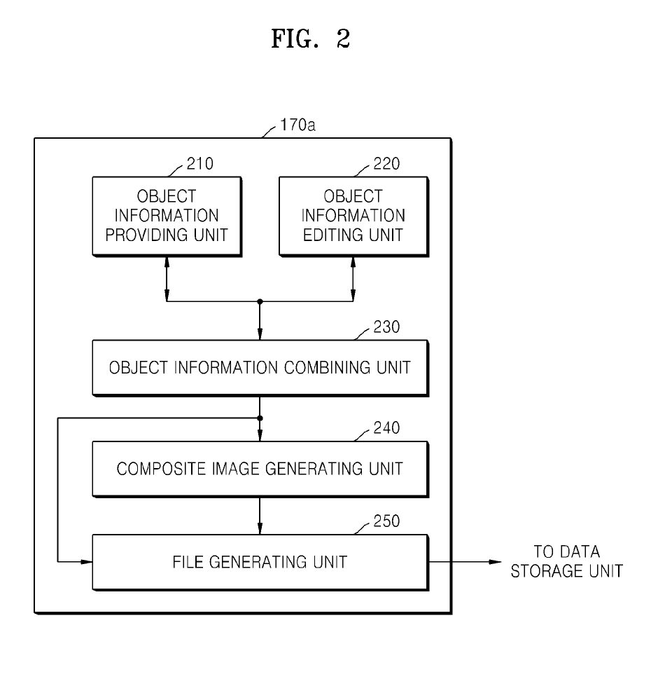

FIG. 2 is a block diagram illustrating a CPU/DSP 170a, according to an exemplary embodiment of the invention. The CPU/DSP 170a may be used to implement the CPU/DSP 170 of FIG. 1.

Referring to FIG. 2, the CPU/DSP 170a may include an object information providing unit 210, an object information editing unit 220, an object information combining unit 230, a composite image generating unit 240, and a file generating unit 250.

In this application, object information relates to a subject and includes additional information such as a title of the subject, a category thereof, a position thereof, a phone number thereof, etc. An example of the object information is augmented reality (AR) content. The AR content includes information regarding a position of an object, a title thereof, an azimuth thereof, etc. at a corresponding position and azimuth according to position and azimuth information of the digital photographing apparatus 100. The AR content is displayed on a corresponding object by overlapping an image photographed by the digital photographing apparatus 100 with the AR content. Therefore, a user may view the AR content regarding a subject at a corresponding position and azimuth and the photographed image together while moving with the digital photographing apparatus 100 in the user's hand or changing an azimuth of the digital photographing apparatus 100. In disclosed embodiments, the object information is AR content. However, the object information may be various other types of information regarding the subject, and is not limited to AR content.

In disclosed embodiments, the photographed image is an image captured by the imaging device 118 and may include a live-view image, a captured image, a reproduced image, etc.

The object information providing unit 210 of the present embodiment acquires object information regarding the captured image by using the position and azimuth information acquired by the position/azimuth information acquiring unit 190 of FIG. 1. For example, the object information providing unit 210 may acquire the AR content at a current position and azimuth through wired and/or wireless communication using an AR application. To this end, the digital photographing apparatus 100 may include a wired and/or wireless communication module (not shown).

The object information combining unit 230 combines the object information provided by the object information providing unit 210 and the captured image provided by the imaging device 118 of FIG. 1 and overlaps the object information and the captured image.

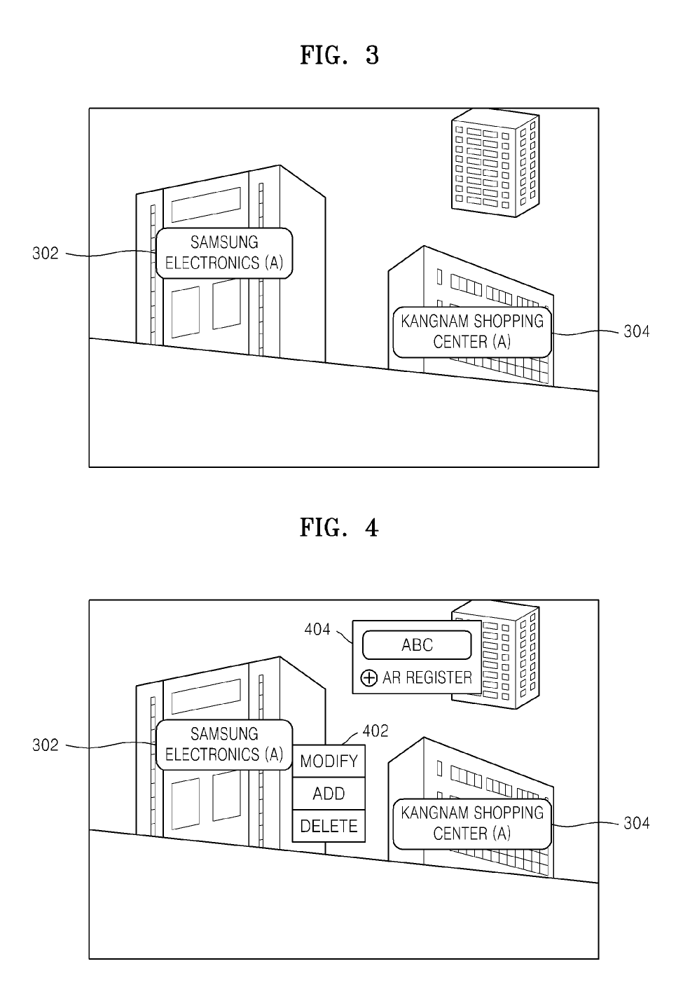

FIG. 3 illustrates a screen displaying a captured image and object information together through the display unit 164 of FIG. 1, according to an exemplary embodiment of the invention.

Referring to FIG. 3, the object information combining unit 230 of FIG. 2 may generate a composite image by overlapping the captured image and object information 302 and 304. To this end, the object information combining unit 230 acquires object information corresponding to the captured image by using the position and azimuth information acquired by the position/azimuth information acquiring unit 190 of FIG. 1, and generates the composite image in which the object information and a corresponding subject in the captured image overlap. The generated composite image may be displayed on the display unit 164 of FIG. 1.

The object information editing unit 220 provides an object information edit interface that is to be used by a user with the object information provided by the object information providing unit 210. The user may partially or wholly delete additional information of the object information displayed on the screen, change a position of the object information, change content of the additional information, or delete the object information through the object information edit interface. The object information edit interface may be executed in any of a live-view mode, a captured image display mode, a photographing mode, and a reproduction mode.

FIG. 4 illustrates a screen displaying an object information edit interface, according to an exemplary embodiment of the invention.

Referring to FIG. 4, a user may select the first object information 302 and move a position of the selected first object information 302. The user may also select the first object information 302 and change content of the selected first object information 302. The user may also select the first object information 302 and delete the selected first object information 302. The object information editing unit 220 may provide an edit menu 402 so as to assist the user in correcting, moving, adding, and deleting object information.

The object information edit interface may provide an object information add menu 404 useable by the user to add new or additional object information. The user may personally add object information that is not provided by the object information providing unit 210 to a captured image through the object information add menu 404. To this end, the object information add menu 404 may include a text input window, an object information register icon, etc.

When the object information is edited, the object information combining unit 230 combines and displays the edited object information and the captured image. Thus, the screen displaying the object information and the captured image together may be continuously updated as the user edits the object information. To this end, the object information combining unit 230 may include a storage medium that stores the object information provided by the object information providing unit 210 and the object information updated by the object information editing unit 220.

When a shutter-release signal is input while the object information is being provided in a live-view mode, the composite image generating unit 240 generates a composite image by combining the object information and a live-view image. Thus, the object information is directly written in pixels of the captured image.

As another example, when the shutter-release signal is input in the live-view mode, the object information is not directly written in the captured image, and the captured image and information regarding a position of the object information on the captured image are stored. When an image file storing the captured image is reproduced, the object information is disposed on the captured image according to the information regarding the position of the object information.

The file generating unit 250 stores the composite image generated by the composite image generating unit 240 and the object information in the image file.

The composite image and the object information may be separately stored in the image file.

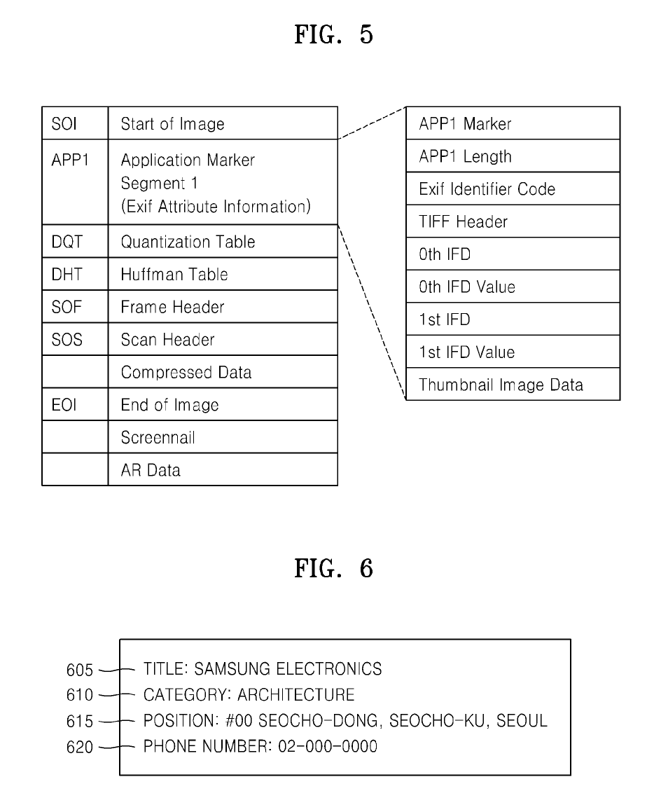

FIG. 5 is a table showing a structure of an image file, according to an exemplary embodiment of the invention. Although the structure of the image file follows the Exif standard, the embodiments of the invention are not limited thereto, and the structure of the image file may be realized in various formats.

Referring to FIG. 5, the image file may have the structure according to an Exif file format. Files compressed in the Exif format may include a start of image (SOI) marker, an application marker segment 1 (APP1) including Exif property information, a quantization table (DQT) region, a Huffman table (DHT) region, a frame header (SOF) region, a scan header (SOS) region, a main image region (compressed data), an end of image (EOI) marker, a screen nail region (ScreenNail), and an object property region (AR data).

The application marker segment 1 (APP1) may include an APP1 marker (APP1 Marker), an APP1 length (APP1 Length), an Exif identifier code (Exif Identifier Code), a TIFF header (TIFF Header), 0^{th} fields recording property information regarding a compressed image (0th IFD, 0th IFD Value), 1^{st} fields storing information relating to a thumbnail (1^{st} IFD, 1st IFD Value), and a thumbnail region (Thumbnail Image Data).

The object property region (AR data) stores object information. The file generating unit 250 of FIG. 2 records the updated object information that is stored in the object information combining unit 230 in the object property region (AR data). As another example, the object information may be provided from the object information providing unit 210 and/or the object information editing unit 220 to the file generating unit 250.

Although the object property region (AR data) is separately included in the Exif file structure in FIG. 5, the object property region (AR data) may be stored in other regions of the Exif file structure like the application marker segment 1 (APP1).

Therefore, the file generating unit 250 may generate an image file that includes a composite image in which the object information is written in the main image region (Compressed data) or that includes the object information in the object property region (AR data). The file generating unit 250 stores the image file in the data storage unit 142 of FIG. 1 through the storage/read control unit 140 of FIG. 2 or directly.

As another example, when the object information is not written in the captured image but the captured image and information regarding a position of the object information are stored, the object information and the information regarding the position of the object information may be stored in the object property region (AR data).

FIG. 6 illustrates information included in object information, according to an exemplary embodiment of the invention.

Referring to FIG. 6, the object information stored in the object property region (AR data) may include various types of additional information such as a title of an object 605, a category 610 thereof, a position 615 thereof, a phone number 620 thereof, etc. The additional information is separately stored for each piece of object information. A user may select a piece of object information from a screen displaying object information and read the additional information. When the user selects optional object information, the screen displays the additional information regarding the selected object information. The user may also edit the additional information through an object information edit interface such as the object information edit interface 402 of FIG. 4.

The user may acquire the object information by searching for other accumulated image files (i.e., image files including object information) even in a no communication environment (i.e., when the digital photographing apparatus 100 is not communicatively coupled with another device). In the present embodiment, the user may edit and store frequently used object information according to the user's preference, thereby easily and quickly acquiring desired object information.

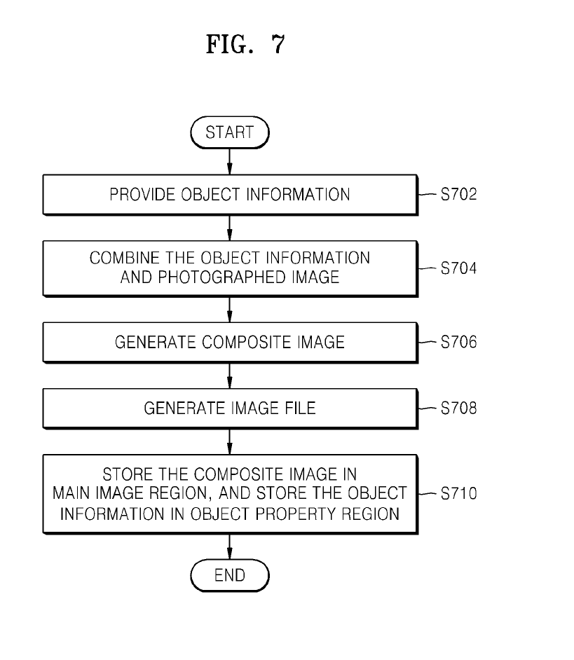

FIG. 7 is a flowchart illustrating a method of generating an image file including object information, according to another embodiment of the invention.

Referring to FIG. 7, object information regarding a photographed image is provided by using position information and azimuth information (operation S702). The object information and the photographed image are combined to generate a composite image that overlaps the object information and the photographed image as shown in FIG. 3 (operation S704). When a shutter-release signal is input while the object information is being provided on a live-view screen, a composite image is generated in which the object information and the photographed image are stored together (operation S706). If the composite image is generated, an image file storing the composite image is generated (operation S708). The composite image is stored in a main image region of the image file, and the object information is stored in an object property region of the image file (operation S710).

As described above, the object information may be corrected, moved, added, or deleted by a user through an object information edit interface, and edited object information may be stored in the image file.

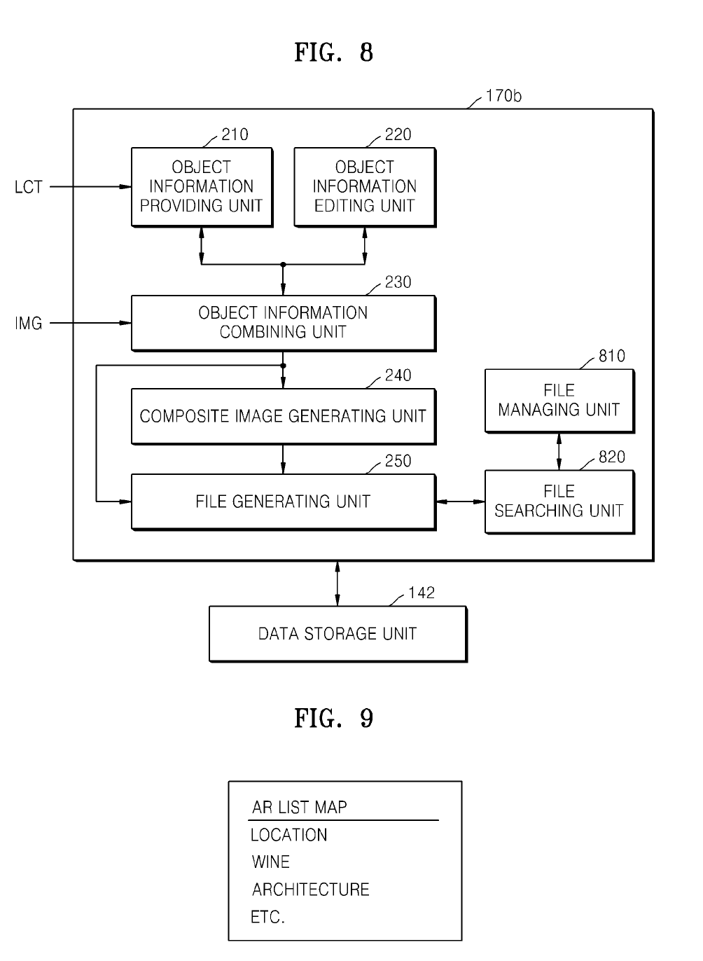

FIG. 8 is a block diagram illustrating a CPU/DSP 170b, according to another exemplary embodiment of the invention. The example CPU/DSP 170b may be used to implement the example CPU/DSP 170 of FIG. 1.

Referring to FIG. 8, the CPU/DSP 170b may include the object information providing unit 210, the object information editing unit 220, the object information combining unit 230, the composite image generating unit 240, the file generating unit 250, a file managing unit 810, and a file searching unit 820.

The file managing unit 810 classifies or arranges image files including object information according to the object information. The image files may be classified or arranged in various ways according to the additional information included in the object information. For example, the file managing unit 810 may arrange the image files according to titles included in the object information. As another example, the file managing unit 810 may classify the image files according to category information included in the object information. As another example, the file managing unit 810 may link each image file on a map by using position information included in the object information.

The file managing unit 810 may classify or arrange the image files according to the object information, and manage the image files by generating a table including the classified or arranged information. The table may be stored in a storage space of the digital photographing apparatus 100 such as a storage space of the data storage unit 142 and the file managing unit 810. When a user accesses the image files arranged or classified by the file managing unit 810, the file managing unit 810 may provide a unit that searches for the table, searches for virtual or physical addresses of the image files, and processes reproduction of the image files by using the virtual or physical addresses.

FIG. 9 illustrates a classification of image files according to categories of object information, according to an exemplary embodiment of the invention.

Referring to FIG. 9, the image files may be classified and managed according to categories. A user may access the image files of each category through an interface. The user may effectively accumulate and manage desired information by using a file management method according to the object information.

The file searching unit 820 provides a search interface useable by the user to search for image files using the object information. When there is object information desired by the user, the file searching unit 820 may search for the image files including the desired information by inputting a title, a category, a position, etc. through the search interface.

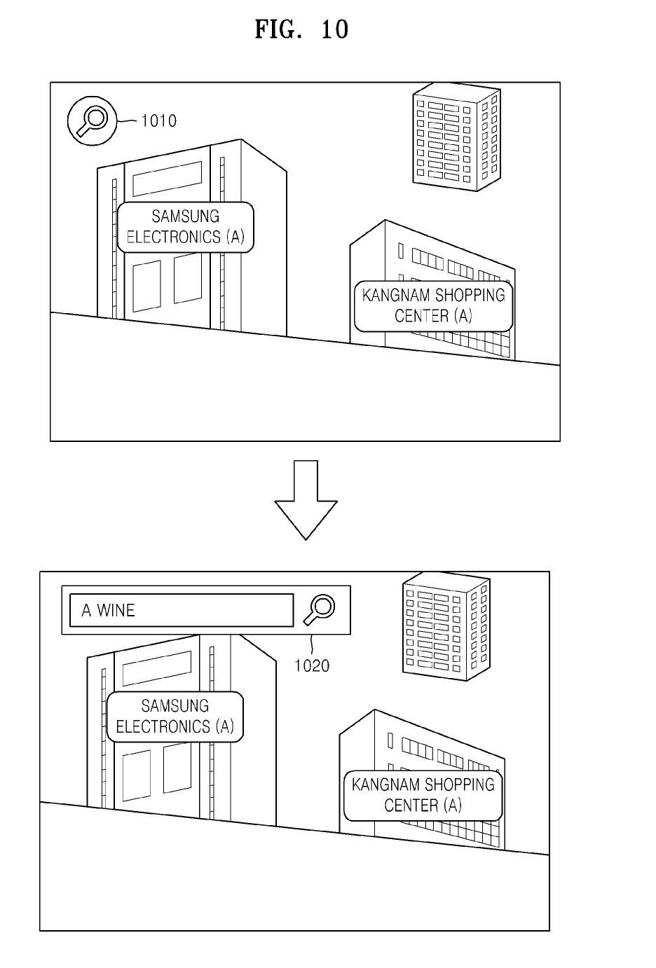

FIG. 10 illustrates a search interface, according to an exemplary embodiment of the invention.

Referring to FIG. 10, the search interface may be provided in various modes such as a live-view mode, a reproduction mode, a user setting mode, a photographing mode, etc. A user may access the search interface by selecting a search icon 1010 displayed on a screen. If the user selects the search icon 1010, a search word input window 1020 may be displayed on the screen. The user may search an image file including desired object information by inputting one or more desired search words in the search word input window 1020. The file searching unit 820 of FIG. 8 may search for additional information included in the object information including the search word(s), search for image files including object information relating to the search word(s), and provide the user with a list of the image files. The search interface of FIG. 10 is exemplary and may be configured in various ways.

The methods disclosed herein may be implemented by computer-readable code that, when executed by a processor such as the CPU/DSP 170, causes the processor to at least perform the methods for controlling digital photographing apparatuses disclosed herein. The computer-readable code may be implemented with various programming languages. Furthermore, functional programs, codes and code segments for implementing the invention may easily be programmed by those skilled in the art.

The embodiments described herein may comprise a memory for storing program data, a processor for executing the program data, a permanent storage such as a disk drive, a communications port for handling communications with external devices, and user interface devices, including a display, keys, etc. When software modules are involved, these software modules may be stored as program instructions or computer-readable codes, which are executable by the processor, on a non-transitory or tangible computer-readable media such as read-only memory (ROM), random-access memory (RAM), a compact disc (CD), a digital versatile disc (DVD), magnetic tapes, floppy disks, optical data storage devices, an electronic storage media (e.g., an integrated circuit (IC), an electronically erasable programmable read-only memory (EEPROM), and/or a flash memory), a quantum storage device, a cache, and/or any other storage media in which information may be stored for any duration (e.g., for extended time periods, permanently, brief instances, for temporarily buffering, and/or for caching of the information). The computer-readable recording medium can also be distributed over network-coupled computer systems (e.g., a network-attached storage device, a server-based storage device, and/or a shared network storage device) so that the computer-readable code may be stored and executed in a distributed fashion. This media can be read by the computer, stored in the memory, and executed by the processor. As used herein, a computer-readable storage medium excludes any computer-readable media on which signals may be propagated. However, a computer-readable storage medium may include internal signal traces and/or internal signal paths carrying electrical signals therein

According to embodiments of the invention, object information indicating information about a subject and a composite image are stored together, thereby accumulating the object information and increasing its utility. The invention also efficiently manages the accumulated object information, and enables searches for the objective information. The invention also allows a user to read the object information from stored image files even in no communication environments.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The invention may be described in terms of functional block components and various processing steps. Such functional blocks may be realized by any number of hardware and/or software components configured to perform the specified functions. For example, the invention may employ various integrated circuit components, e.g., memory elements, processing elements, logic elements, look-up tables, and the like, which may carry out a variety of functions under the control of one or more microprocessors or other control devices. Similarly, where the elements of the invention are implemented using software programming or software elements the invention may be implemented with any programming or scripting language such as C, C++, Java, assembler, or the like, with the various algorithms being implemented with any combination of data structures, objects, processes, routines or other programming elements. Functional aspects may be implemented in algorithms that execute on one or more processors. Furthermore, the invention could employ any number of conventional techniques for electronics configuration, signal processing and/or control, data processing and the like. The words “mechanism” and “element” are used broadly and are not limited to mechanical or physical embodiments, but can include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

The use of the terms “a” and “an” and “the” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The use of any and all examples, or exemplary language (e.g., “such as” or “for example”) provided herein, is intended merely to better illuminate the invention and does not pose a limitation on the scope of the invention unless otherwise claimed. Numerous modifications and adaptations will be readily apparent to those skilled in this art without departing from the spirit and scope of the invention.

What is claimed is:

1. A method of controlling an image taking apparatus, the method comprising:
arranging object information on a taken image, wherein the taken image and the object information indicate information regarding a subject;
generating a capture image by combining the taken image and the object information; and
generating an image file including the capture image.

2. The method of claim 1, further comprising:
arranging the object information nearby the subject corresponding the object information.

3. The method of claim 1, further comprising:
editing the object information;
generating the capture image by combining the edited object information and the taken image; and
generating the image file including the edited object information in the object property region.

4. The method of claim 3, wherein the editing of the object information comprises at least one of the following operations:
adding information input by a user to the object information;
modifying the object information according to a user's input; and
excluding the object information deleted by the user from the object information.

5. The method of claim 1, further comprising:
identifying property of the object information; and
managing the image file according to the identified property of the object information.

6. The method of claim 1, further comprising:
searching for the image file according to the object information.

7. The method of claim 1, wherein the object information is information regarding the subject provided through augmented reality (AR).

8. The method of claim 7, further comprising:
providing the object information by searching for the object information according to a photographing position and a photographing azimuth.

9. An image taking apparatus, comprising:
an imaging device for taking an image;
an object information combining unit that arranges object information on a taken image and combines the taken image and the object information indicating information regarding a subject;
a capture image generating unit that generates a capture image by combining the taken image and the object information; and
a file generating unit that takes an image file including the capture image in a main image region and including the object information in an object property region.

10. The image taking apparatus of claim 9, wherein the object information combining unit arranges the object information nearby the subject corresponding the object information.

11. The image taking apparatus of claim 9, further comprising:
an object information editing unit that edits the object information, wherein the capture image generating unit generates the capture image by combining the edited object information and the taken image; and
the file generating unit generates the image file including the edited object information in the object property region.

12. The image taking apparatus of claim 11, wherein the object information editing unit adds information input by a user to the object information, modifies the object information according to a user's input, or excludes the object information deleted by the user from the object information.

13. The image taking apparatus of claim 9, further comprising:
a file managing unit that identifies a property of the object information and manages the image file according to the identified property of the object information.

14. The image taking apparatus of claim 9, further comprising:
a file searching unit that searches for the image file according to the object information.

15. The image taking apparatus of claim 9, wherein the object information is information regarding the subject provided through AR.

16. The image taking apparatus of claim 15, further comprising:
an object information providing unit that provides the object information by searching for the object information according to a photographing position and a photographing azimuth.

17. A non-transitory computer readable recording medium having a computer readable program code embodied therein adapted to be executed to implement a method of controlling an image taking apparatus, the method comprising:
arranging object information on a taken image;
combining the taken image and object information indicating information regarding a subject;
generating a capture image by combining the taken image and the object information; and
generating an image file including the capture image.

18. The computer-readable medium of claim 17, wherein the method further comprises:
arranging the object information nearby the subject corresponding the object information.

19. The computer-readable medium of claim 17, wherein the method further comprises:
editing the object information;
generating the capture image by combining the edited object information and the taken image; and
generating the image file including the edited object information in the object property region.

20. The computer-readable medium of claim 19, wherein the editing of the object information comprises at least one of the following operations:
adding information input by a user to the object information;
modifying the object information according to a user's input; and
excluding the object information deleted by the user from the object information.

21. The computer-readable medium of claim 17, wherein the method further comprises:
identifying a property of the object information; and
managing the image file according to the identified property of the object information.

22. The computer-readable medium of claim 17, wherein the method further comprises:
searching for the image file according to the object information.

23. The computer-readable medium of claim 17, wherein the object information is information regarding the subject provided through AR.

24. The computer-readable medium of claim 23, wherein the method further comprises:
providing the object information by searching for the object information according to a photographing position and a photographing azimuth.
